(19) United States
(12) Patent Application Publication
(10) Pub. No.: US 2010/0102699 A1
(43) Pub. Date: Apr. 29, 2010

(54) Discharge Lamp and Method for Producing a Discharge Lamp

(75) Inventors: Rainer Koger, Berlin (DE); Karsten Schwandt, Berlin (DE); Ralf Dotterweich, Berlin (DE); Piotr Kreft, Fredersdorf (DE)

Correspondence Address: COHEN, PONTANI, LIEBERMAN & PAVANE LLP, 551 FIFTH AVENUE, SUITE 1210, NEW YORK, NY, 10176, US

(73) Assignee: OSRAM GESELLSCHAFT mit beschrankter Haftung, Munich (DE)

(21) Appl. No.: 12/530,754

(22) PCT Filed: Mar. 12, 2007
(86) PCT No.: PCT/EP07/52279

§ 371 Date: Nov. 5, 2009

(51) Int. Cl. H01J 1/88; H01J 9/24

(52) U.S. Cl. 313/292; 445/23

(57) ABSTRACT

A discharge lamp having a discharge vessel (2) that comprises at least one bulb neck (21, 22), into which are fused a holding rod (6) extending into the discharge space (3) for an electrode (4, 5), a carrier part (10) on which at least one current-carrying element (9) is arranged, a support element (7) enclosing the holding rod (6) and a tube (13) enclosing the carrier part (10) with the current-carrying element. The tube (13) encloses the support element (7) over a partial length (L3) which is less than the total length (L) of the support element (7).

### TECHNICAL FIELD

The invention relates to a discharge lamp, in particular a high-pressure discharge lamp, having a discharge vessel that comprises at least one bulb neck, into which a holding rod extending into the discharge space for an electrode, a carrier part on which at least one current-carrying element is arranged, a support element enclosing the holding rod and a tube enclosing the carrier part with the current-carrying element are fused. The invention also relates to a method for producing such a discharge lamp.

### PRIOR ART

High-pressure discharge lamps, in particular mercury vapor lamps (HBO lamps), which are used for example in the semiconductor industry or for the production of LCD (liquid-crystal display) panels, are operated with a high operating pressure and high electrical powers in order to be able to optimize the required power of the emitted UV (ultraviolet) radiation.

With an increasing electrical power of the lamp, for thermal reasons the size, in particular the length and diameter, of the lamp also increases. The size of the electrodes used, and their masses, likewise increase. Furthermore the holding rods, which are used for mounting the electrodes in the discharge vessel, become longer.

FIG. 1 shows a schematic representation of a high-pressure discharge lamp 1 known from the prior art. The high-pressure discharge lamp 1 comprises a discharge vessel 2 which is formed in one piece from quartz glass and has a widening metal part on which two bulb necks 21 and 22 are formed diametrically opposite each other. The entire discharge vessel 2, with its centrally ovally shaped subregion 23 and the bulb necks 21 and following the latter on either side, is made of quartz glass. A discharge space 3, into which a cathode 4 and an anode 5 extend, is formed inside the ovally shaped central subregion 23 of the discharge vessel 2. The cathode 4 is fastened on a holding rod 6, which may for example be made of tungsten. This holding rod 6 extends locally into the discharge space 3 and into the bulb neck 21. The holding rod 6 is surrounded by a support sleeve 7, which is designed so that it tapers in the direction of the discharge space 3. On the side of the support sleeve 7 facing away from the discharge space 3, a plate 8 is arranged which is likewise made of molybdenum and is connected to a foil system 9, which is arranged on a lateral surface of a quartz rod 10. The foil system 9 comprises a multiplicity of foil strips, which are made of molybdenum and are used to supply current to the cathode 4. On the opposite end side of the quartz rod 10, another plate 11 is arranged which is likewise connected to the foil system 9 and furthermore comprises a connection to a further rod-shaped electrical lead 12. The support sleeve 7, the two plates 8, 11, the foil system 9

and the quartz rod 10 are fused hermetically into the tubularly shaped bulb neck 21.

In a corresponding way, the anode 5 is arranged on a holding rod (not referred to in detail) which likewise extends into the discharge space 3 and the bulb neck 22. The rest of the arrangement and configuration of the components is also provided in the bulb neck 22 as it is designed in the region of the cathode 4 in the bulb neck 21.

The originally tubular quartz glass of the bulb neck 21 opens in the region 2a into the widening central part of the discharge vessel 2, the originally tubular bulb neck 22 opening into this central part of the discharge vessel 2 in the region 2b.

Owing to the increasing size of the lamps, in particular the electrodes used and their masses, these high-pressure discharge lamps are relatively sensitive to shock stresses, such as may occur with relatively strong short-term forces exerted for example during transport. This may lead to fracture of the quartz glass, particularly in the region of the plate 8. Furthermore, high stresses occur in the quartz glass owing to the high operating pressure, particularly in the sealing region in the vicinity of the plate 8. This may lead to failure of the high-pressure discharge lamp 1.

JP 2005243484 A discloses a discharge lamp in which a foil system is applied onto a quartz rod and connected to plates applied on either side of the quartz rod. This arrangement is then fitted into a quartz tube. This entire system, comprising the

quartz rod with the foil system and the plates and the quartz glass tube is then fitted inside a bulb neck of a discharge vessel and fused in there.

Even by this procedure, the fracture stability in the region of the plate and/or a support element can be improved only insubstantially for relatively large-dimensioned high-pressure discharge lamps. Furthermore, the production and hermetic fusing in are expensive.

With an increasing electrical power of the lamp, for thermal reasons the length of this lamp increases, and therefore so does the length of current-carrying foils which are arranged on a quartz rod inside the bulb neck. In the sealing region of the lamp, a molybdenum foil is fused into the quartz glass. Since the expansion coefficient of molybdenum is greater than the expansion coefficient of the quartz glass, the sealing foil is lengthened more than the quartz glass during the process of fusing in. The foil begins to buckle. Cavities can then be formed where the quartz glass joins with the foil. This can lead to deficient vitrification of the foil onto the quartz glass in the manufacturing process, and therefore to foil detachment and crevices. Furthermore, with strong expansion of the sealing foils, the electric system which has not yet been fused in is relatively labile. This makes the process of fusing in more difficult, and it takes more time. Cavities, foil detachment or crevices increase the reject rate during manufacture or can lead to lamp failure. They can also lead to a reduced lamp lifetime.

A relatively minor improvement to these problems can be provided by adapting the quartz glass inner diameter to the electrode system, although this can only be done to a limited extent. With large electrode diameters as required for high-power lamps, however, this procedure is possible only to a very limited extent since the electrode has to be inserted through the stem tube or the bulb neck into the bulb or the discharge vessel. Particularly in the case of long foil systems with large electrode diameters, this process management procedure can only be carried out with great difficulty and leads to unsatisfactory results. A further option is to match the system length to the length of the expanded foil during the process of fusing in by pulling in the axial direction or rotating the foil system relative to the electrodes. This is also relatively expensive and leads only to a suboptimal result.

### SUMMARY OF THE INVENTION

It is an object of the present invention to provide a discharge lamp and a method for producing a discharge lamp, by which the occurrence of such cavities or detachment of current-carrying or sealing elements or material discontinuities can at least be reduced.

This object is achieved by a discharge lamp which has the features as claimed in claim 1, and by a method which has the features as claimed in claim 12.

A discharge lamp according to the invention is designed in particular as a high-pressure discharge lamp, for example as an HBO lamp. The discharge lamp comprises a discharge vessel, which has at least one bulb neck. A holding rod extending into the discharge space of the discharge vessel for an electrode, a carrier part on which at least one current-carrying element is arranged, a support element enclosing the holding rod and a tube enclosing the carrier part with the current-carrying element are fused into this bulb neck. These so-called components are therefore arranged in the stem tube of the bulb neck and surrounded by it. The tube, which at least locally encloses the carrier part with the current-carrying element, is therefore likewise arranged inside the stem tube of the bulb neck and encloses the support element over a partial length which is less than the total length of this support element.

Owing to this configuration of the discharge lamp in the region of a bulb neck, the formation of cavities or detachment of the current-carrying element or even so-called crevices can at least be reduced. In particular during the process of fusing in, the occurrence of said problems can at least be reduced through the arrangement and dimensioning of the components with respect to one another. The reject rate during the manufacture of such discharge lamps can therefore be substantially reduced. Furthermore, the failure rate of such discharge lamps can be minimized and the lamp lifetime can be increased.

Preferably, the support element extends with a length of more than 2.5 mm, in particular more than 3 mm, out of the tube which at least locally encloses the carrier part with the current-carrying element. This arrangement is preferably to be applied in particular before the process of fusing the components into the bulb neck.

The tube is preferably designed as a quartz tube, and owing to the special dimensioning, in particular during the process of fusing in, the formation of cavities or detachment of the current-carrying elements or the occurrence of crevices can be prevented.

The current-carrying elements are furthermore also formed as sealing elements and preferably designed as foil strips. These may in particular be made of molybdenum. Preferably a multiplicity of such foils are arranged on the outside of the carrier part, which is designed in particular as a quartz rod, and extend essentially over the entire length of the quartz rod.

The inner diameter of this tube, particularly before fusing the arrangement or components into the bulb neck, is greater than the outer diameter of the carrier part with the current-carrying element arranged on it and less than this outer diameter plus approximately 3 mm. This configuration of the tube, in particular before the process of fusing in, can allow ideal fitting and insertion over the carrier part with the current-carrying element, and permits optimal stabilization during the process of fusing in. Furthermore, during the process of fusing in, this configuration can have the effect that the current-carrying and sealing element joins better with the quartz glass of the tube. Diameter

differences between the system of the current-carrying and sealing elements, in particular the foil system, and the inner diameter of the stem tube of the bulb neck, which result in particular owing to the size of the electrode to be fitted, in particular the anode, can thus be reduced.

The wall thickness of the tube is preferably between 1.8 mm and 4.5 mm, in particular between 2 mm and 4 mm.

The quality of the fusing in can be improved further by this dimensioning.

Owing to these specific dimensionings of the tube, which at least locally surrounds the carrier part and the current-carrying element, the bursting pressure stability of the sealing region in this bulb neck can be increased further and the lamp lifetime can therefore also be extended.

The tube preferably encloses the carrier part and the current-carrying element arranged on it over a partial length which is less than the total length of the carrier part. The support elements and the carrier part with the current-carrying element arranged on it are arranged behind one another as seen in the longitudinal direction of the bulb neck, and the tube therefore preferably encloses both the support element and this carrier part with the current-carrying element, in each case at least locally. In this way, the occurrence of cavities, foil detachment and the like can in particular also be prevented effectively at the transition region between the support element and the carrier part with the foil system.

Preferably, the support element comprises a first subelement which at least at one position has an outer diameter greater than the inner diameter of the tube at the inner end facing the support element. This first subelement can therefore be used essentially as a stop for the tube and exact positioning of the components can be ensured before fusing in. Furthermore, the tube can be prevented from sliding over beyond this edge formed by the subelement. Very exact arrangement of the individual subcomponents with respect to one another can therefore be stably ensured.

Preferably, the first subelement at least at one position has an outer diameter which is greater than or equal to the outer diameter of the tube at the end facing the support element. The advantages mentioned above can be further improved by this configuration.

Preferably, the support element comprises a frustoconical first subelement and a cylindrical second subelement. Preferably, the cylindrical second subelement has an outer diameter which corresponds essentially to the outer diameter of the carrier part with the current-carrying element arranged on it. This configuration can allow particularly expedient and straightforward fitting of the tube around the second subelement of the support element as well as the carrier part with the current-carrying element. A virtually flush transition can therefore essentially be achieved between the second subelement of the support element, a plate following it and a carrier part in turn following the latter

with the current-carrying element arranged on it.

Preferably, a transition between the support element's first subelement and its second subelement following the latter is designed in a stepped fashion. Owing to such a discrete step, the support element can essentially also be designed in an undercut fashion, so that an effective stop for the tube can be formed and it is furthermore possible to define more accurately the length over which the tube is intended to enclose the support element, and this length can also be complied with exactly at the target position.

Preferably, the outer diameter of the second subelement is less than the inner diameter of the tube at the tube's end side facing the support element.

Preferably, the tube encloses the support element at most over the length of the second subelement.

Another aspect of the invention relates to a method for producing a discharge lamp, in which a discharge vessel having at least one bulb neck is formed, and a holding rod for the electrode, a carrier part on which at least one current-carrying element is arranged, a support element enclosing the holding rod and a tube enclosing the carrier part with the current-carrying element are fused into the bulb neck. The tube is fused in so that it encloses the support element over a partial length which is less than the total length of this support element. Owing to this arrangement and dimensioning of the tube, in particular during the process of fusing in, it is possible at least to reduce significantly the formation of cavities, detachment of the current-carrying element, in particular the foil system, and the

occurrence of crevices.

Preferably, the support element before fusing in is arranged so that it extends out of the tube with a length of more than 2.5 mm, in particular more than 3 mm. In particular, this extra length of the support element is formed on the side facing the electrode.

Before fusing in, the tube is preferably provided with an inner diameter which is greater than the outer diameter of the carrier part with the current-carrying element arranged on it, and less than this outer diameter plus approximately 3 mm.

Owing to the special dimensioning of this tube, the current-carrying element also designed for sealing, in particular a molybdenum foil system, is stabilized during the process of fusing in and can join better with the quartz glass of the tube. Diameter differences between the foil system diameter and the inner diameter of the stem tube of the bulb neck, which occur in particular owing to the electrode to be fitted into the discharge vessel, can thus be reduced. The quality of the fusing in is thereby substantially improved.

Advantageous configurations of the discharge lamp according to the invention are to be regarded as advantageous configurations of the method according to the invention.

### BRIEF DESCRIPTION OF THE DRAWING(S)

Exemplary embodiments of the invention will be explained in more detail below with the aid of schematic drawings, in which:

FIG. 1 shows a sectional representation of a high-pressure discharge lamp known from the prior art;

FIG. 2 shows a sectional representation through a subregion of a discharge lamp according to the invention;

FIG. 3 shows a sectional representation through a subregion of a discharge lamp according to the invention according to another exemplary embodiment.

### PREFERRED EMBODIMENTS OF THE INVENTION

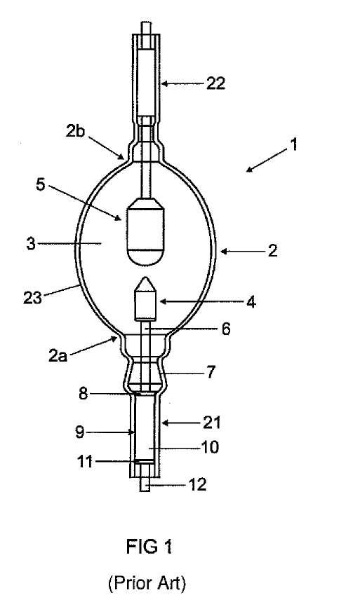

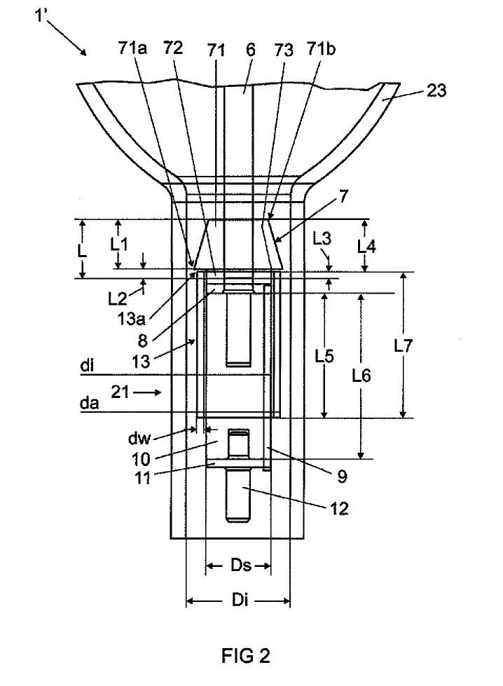

FIG. 2 shows a schematic sectional representation of a subregion of a discharge lamp 1′ according to the invention, which is designed as a high-pressure discharge lamp. Basically, this discharge lamp 1′ is produced according to the configuration in FIG. 1. As an essential difference therefrom, however, it has a configuration according to FIG. 2 in the region of the bulb neck 21. In a similar way, this configuration in the region of the bulb neck 21, as shown in FIG. 2, is also produced in the region of the bulb neck 22. The configuration at the bulb neck 21 will be explained in more detail by way of example.

Arranged in regions inside the stem tube of the bulb neck 21, which emerges in the region 2a into the central part or ovally shaped subregion 23 of the discharge vessel 2, are the holding rod 6, the support part designed as a support sleeve 7 made of quartz glass, the plate 8 which follows this and the carrier part following the plate 8 in the longitudinal axis direction A. The carrier part is designed as a cylindrical quartz rod 10, which comprises bores to receive the holding rod 6 on the one hand and to receive the rod-shaped electrical lead 12 on the other hand. A multiplicity of current-carrying elements, which additionally have a sealing function, are arranged on the outside of the quartz rod 10. The current-carrying elements are designed as molybdenum foil strips 9 and extend over the entire length of the quartz rod 10.

A tube 13 made of quartz glass is furthermore arranged inside the bulb neck 21. This tube 13 locally surrounds the support sleeve 7 and locally surrounds the quartz rod 10 with the foil strips 9.

FIG. 2 shows a representation of how the components are arranged inside the bulb neck 21 before the subsequent process of fusing in. It may be seen there that the support sleeve 7 comprises a first subelement 71 and a second subelement 72. The first subelement 71 is designed frustoconically, and the cylindrical second subelement 72 is arranged immediately following it. The support sleeve 7 has a through-bore, through which the holding rod 6 is fed.

According to the embodiment shown in FIG. 2, a transition 73 between the first subelement 71 and the second subelement 72 is designed in a stepped fashion. The outer diameter of the second subelement 72 is less than

the outer diameter of the first subelement 71 at the end 71a facing the second subelement 72.

In the exemplary embodiment, the outer diameter at this end 71a is furthermore also slightly greater than an outer diameter da of the tube 13 at the end 13a facing the first subelement 71.

An inner diameter di of the tube 13 is greater than the outer diameter of the quartz rod 10 with the foil strips 9 arranged on it. In particular, however, this inner diameter di is less than the outer diameter of the quartz rod 10 with the foil strips 9 arranged on it plus 3 mm. This means that the tube 13 can readily be inserted in a straightforward fashion with an air gap over the quartz rod 10 with the foil strips 9, but the subsequent fusing in only gives an air gap which is so small that fusing in can be ensured without leaving a cavity.

In the exemplary embodiment, the outer diameter of the second subelement 72 is dimensioned so that it substantially corresponds to the outer diameter of the plate 8 and the outer diameter of the quartz rod 10 with the foil strips 9 arranged on it.

The wall thickness dw of the tube 13 is preferably between 2 mm and 4 mm.

In the exemplary embodiment, this is less than the wall thickness of the stem tube of the bulb neck 21.

The inner diameter Di of the stem tube of the bulb neck 21 is preferably about 1 mm greater than the diameter of the anode 5. The diameter Ds of the quartz rod 10 with the foil strips 9 arranged on it is preferably between 17 mm and 30 mm.

The support sleeve 7 has a total length L which may lie between 17 mm and 28 mm. A length L1 of the first subelement 71 in the exemplary embodiment is greater than a length L2 of the second subelement 72. In the exemplary embodiment shown, the tube 13 encloses the support sleeve 7 merely in the second subelement 72 over a length L3. As is shown, the front end 13a of the tube 13 is at a distance from the first subelement 71. This first end 13a of the tube 13 is therefore separated by a length L4 from a front end 71b of the support sleeve 7.

Provision may also be made for the tube 13 to bear with its end 13a facing the first subelement 71 directly on the stop formed by the transition 73.

The tube 13 encloses the quartz rod 10 with the foil strips 9 over a length L5, which is less than the total length L6 of the quartz rod 10 with the foil system or the current-carrying elements 9.

The length L6 is preferably between 40 mm and 80 mm.

The tube 13 has a length L7, which may preferably lie between 20 mm and 90 mm.

The length L4 is in particular greater than 3 mm and less than the total length L.

Likewise, provision may also be made for the tube 13 to enclose the quartz rod 10 and the foil strips 9 arranged on it over the entire length L6, and in particular also over the length of the plate 11.

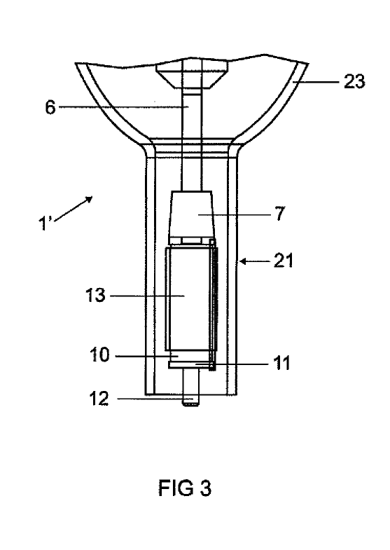

FIG. 3 shows a sectional representation of a subregion of the discharge lamp 1′ according to another exemplary embodiment. Unlike in the configuration according to FIG. 2, here the support sleeve 7 is likewise designed conically or represents a conic frustum, although on the side facing the tube 13 it is designed with an outer diameter which is less than the inner diameter Di of the tube 13.

1. A discharge lamp having a discharge vessel that comprises at least one bulb neck, into which are fused a holding rod extending into the discharge space for an electrode, a carrier part on which at least one current-carrying element is arranged, a support element enclosing the holding rod and a tube enclosing the carrier part with the current-carrying element, wherein the tube encloses the support element over a partial length which is less than the total length of the support element.

2. The discharge lamp as claimed in claim 1, wherein the support element extends out of the tube with a length of more than 2.5 mm.

3. The discharge lamp as claimed in claim 1, wherein the inner diameter of the tube before fusing in is greater than the outer diameter of the carrier part with the current-carrying element arranged on it, and less than this outer diameter plus approximately 3 mm.

4. The discharge lamp as claimed in claim 1, wherein the wall thickness of the tube is between 1.8 mm and 4.5 mm.

5. The discharge lamp as claimed in claim 1, wherein the tube surrounds the carrier part, and the current-carrying element arranged on it, over a partial length which is less than the total length of the carrier part.

6. The discharge lamp as claimed in claim 1, wherein the support element comprises a first subelement which at least at one position has an outer diameter greater than the inner diameter of the tube at the end facing the support element.

7. The discharge lamp as claimed in claim 1, wherein the first subelement at least at one position has an outer diameter which is greater than or equal to the outer diameter of the tube at the end facing the support element.

8. The discharge lamp as claimed in claim 1, wherein the support element comprises a frustoconical first subelement and a cylindrical second subelement.

9. The discharge lamp as claimed in claim 8, wherein the transition between the first subelement and the second subelement following it is formed in a stepped fashion.

10. The discharge lamp as claimed in claim 8, wherein the outer diameter of the second subelement is less than the inner diameter of the tube at the end of the tube facing the support element.

11. The discharge lamp as claimed in claim 8, wherein the tube surrounds the support element at most over the length of the second subelement.

12. A method for producing a discharge lamp, in which a discharge vessel having at least one bulb neck is formed, and into which said bulb neck are fused a holding rod for the electrode, a carrier part on which at least one current-carrying element is arranged, a support element enclosing the holding rod and a tube enclosing the carrier part with the current-carrying element, wherein the tube is fused in so that it encloses the support element over a partial length which is less than the total length of the support element.

13. The method as claimed in claim 12, wherein the support element before fusing in is arranged so that it extends out of the tube with a length of more than 2.5 mm.

14. The method as claimed in claim 12, wherein the tube before fusing in is provided with an inner diameter which is greater than the outer diameter of the carrier part with the current-carrying element arranged on it, and less than this outer diameter plus approximately 3 mm.
